(19) United States
(12) Patent Application Publication
(10) Pub. No.: US 2026/0025794 A1
(43) Pub. Date: Jan. 22, 2026

(54) Alarm Status Tracker

(71) Applicant: Vivint LLC, Provo, UT (US)

(72) Inventors: Morgan Wheaton, Provo, UT (US); Ethan Lawrence, Provo, UT (US); Nathan Wall, Provo, UT (US)

(73) Assignee: Vivint LLC, Provo, UT (US)

(21) Appl. No.: 19/272,384

(22) Filed: Jul. 17, 2025

Related U.S. Application Data
(60) Provisional application No. 63/672,903, filed on Jul. 18, 2024.

(51) Int. Cl. H04W 68/00; H04W 4/90; H04W 64/00

(52) U.S. Cl. CPC H04W 68/00; H04W 4/90; H04W 64/00

(57) ABSTRACT

Systems and methods for monitoring dispatch notification are disclosed. One method of providing notifications to a user includes, in response to receiving an alarm trigger from an alarm system from amongst multiple alarm systems being used to monitor respective locations, initiating a sequence of actions to be performed to protect the user of the alarm system. In response to a first action of the sequence of actions being initiated by a monitoring service, a first message indicating that the first action has been initiated may be generated and communicated via a communications network to a network address associated with the user. In response to at least one second action being initiated, at least one second message indicating that the second action has been initiated may be generated and communicated via the communications network to the network address associated with the user.

### CROSS REFERENCE TO RELATED APPLICATION

This application is a claims priority to U.S. Patent Application Ser. No. 63/672,903, filed Jul. 18, 2024, the entire contents of which are hereby incorporated by reference as though fully set forth herein.

### TECHNICAL FIELD

The current disclosure generally relates to smart home security systems and notifications during emergency events.

### BACKGROUND

Emergency events come in various forms. Home security systems and mobile apps may be used to communicate the emergency event and related details to a monitoring service or event center such that an operator thereat may perform an emergency dispatch to the proper authority (e.g., fire, police, ambulance, etc.). However, while the home security system or monitoring service may be provided with details about the emergency and further perform various steps based on the emergency event and details provided, users experiencing the emergency event receive only basic notifications, such as confirmations of receipt and dispatch sent from the monitoring service. And, because of the limited information received about emergency services (e.g., police, fire, medical, etc.), the users have little information and thus are often unable to manage the high stress situation, which often leads to panic, injury, or death. As such, there is a need to provide more information to users in emergency situations.

### SUMMARY

To overcome the shortcomings of existing limited dispatch notifications, systems and methods for an alarm status tracker to provide monitoring dispatch notifications with higher resolution are provided. The principles described herein provide a series of interactive messages/features related to an emergency event and a monitoring service's current and future activities (e.g., information related to one or more dispatch actions being taken to protect the user) to the user via a graphical user interface (GUI) executing on a mobile application of the user's mobile device. In some embodiments, the principles described herein allow the user to further respond via the GUI and receive updated notifications based on the user's responses.

One method of providing notifications to a user of an alarm system may include, in response to receiving an alarm trigger from an alarm system from amongst multiple alarm systems being used to monitor respective locations, initiating a sequence of actions to be performed to protect the user of the alarm system. In response to a first action of the sequence of actions being initiated, the method may include generating a first message indicating that the first action has been initiated and communicating the first message via a communications network to a network address associated with the user. In response to at least one second action being initiated, the method may include generating at least one second message indicating that the second action has been initiated and communicating the second message via the communications network to the network address associated with the user.

Another embodiment relates to a system of providing notifications to a user of an alarm system including a non-transitory memory, an input/output (I/O) unit, and one or more processors in communication with the memory and I/O unit. In response to receiving an alarm trigger from an alarm system from amongst multiple alarm systems being used to monitor respective locations, the one or more processors) may initiate a sequence of actions to be performed to protect the user of the alarm system. In response to a first action of the sequence of actions being initiated, the one or more processors may generate a first message indicating that the first action has been initiated and communicate the first message via a communications network to a network address associated with the user. In response to at least one second action in the sequence of actions being initiated, the one or more processors can generate at least one second message indicating that the second action has been initiated and communicate the at least one second message via the communications network to the network address associated with the user.

One method of notifying a user of an alarm system of actions being performed in service an alarm activation includes receiving, by the user via an electronic device, a first user-interactive message indicating that a first action of a sequence of actions to be performed in servicing the alarm activation has been initiated. The method may further include receiving at least one second user-interactive message indicating that at least one second action of the sequence of actions to be performed in servicing the alarm activation has been initiated, and the first and second messages may be different from one another.

Another embodiment relates to a system of notifying a user of an alarm system of actions being performed in servicing an alarm activation, including a non-transitory memory, an input/output (I/O) unit, and one or more processors in communication with the memory and I/O unit. The or more processors may be configured to receive, by a user via an electronic device, a first user-interactive message indicating that a first action of a sequence of actions to be performed in servicing the alarm activation has been initiated. Further, the one or more processors may be configured to receive at least one second user-interactive message indicating that at least one second action of the sequence of actions to be performed in servicing the alarm activation has been initiation, and the first and second messages may be different from one another.

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a perspective view illustrating one embodiment of a security system of a residence, according to some embodiments;

FIG. 2 is a block diagram of a system including a network environment inclusive of a home security system (e.g., hub) at a residence, monitoring service in communication with the home security system of the residence, and emergency services with which the monitoring service may communicate in the event of an emergency event reported to the monitoring service, according to some embodiments;

FIG. 3 is an illustrative controller configured to operate a hub or other electronic device configured to support an application, such as a mobile app, for monitoring dispatch notification, according to some embodiments;

FIG. 4 is an illustrative electronic device used for providing monitoring dispatch notifications to a user, according to some embodiments;

FIG. 5 is an illustrative system including an electronic device for receiving monitoring dispatch notifications, according to some embodiments;

FIG. 6 is an illustrative system for responding to notifications via an electronic device, according to some embodiments;

FIG. 7 is an illustrative system for accessing a home security mobile application via a monitoring dispatch notification, according to some embodiments;

FIG. 8 is a “swim-lane” flowchart of an illustrative process for providing or receiving monitoring dispatch notifications, according to some embodiments;

FIG. 9 is a flowchart of an illustrative process for monitoring dispatch notification, according to some embodiments; and

FIG. 10 is a flowchart of an illustrative process for providing notifications to a user of an alarm system, according to some embodiments.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

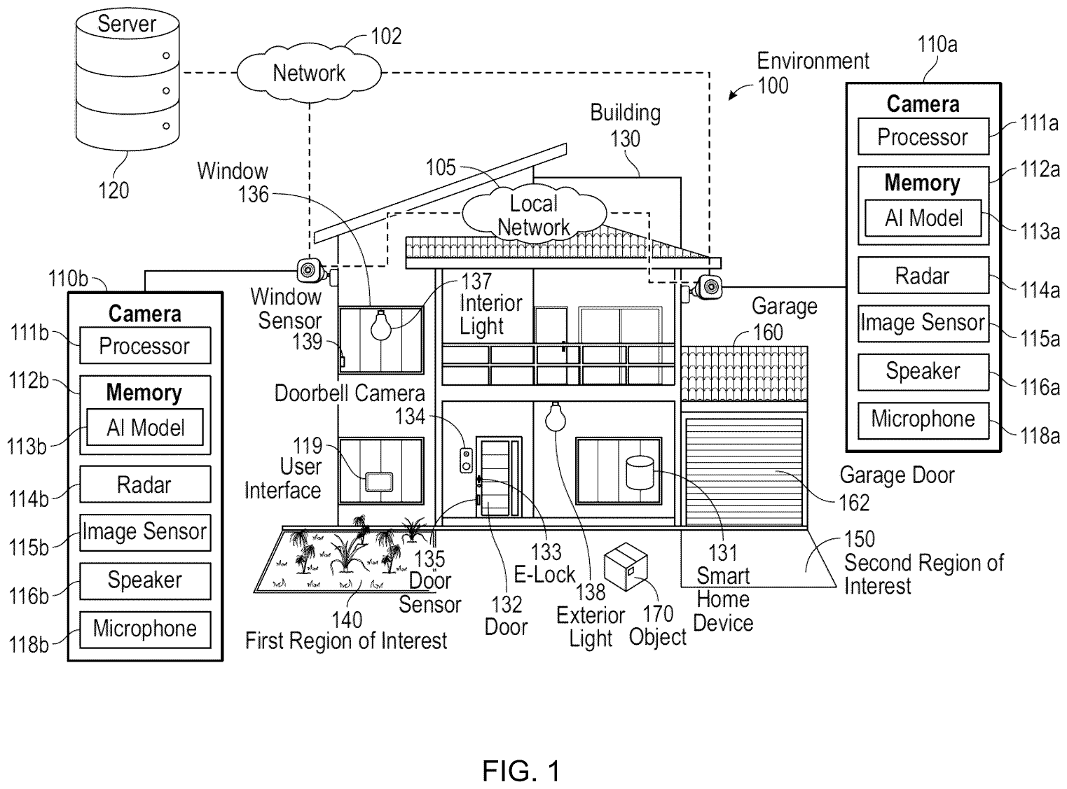

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more

Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee@ bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116. The speaker(s) 116 may be independent from other devices or integrated therein. For example, the camera(s) may include one or more speakers 116 (e.g. speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio from the speaker(s) 116 located at the building 130. In an embodiment, one or more sounds may be output in response to detecting the presence of a human within an area. For example, the controller may cause the speaker may play one or more sounds selected to deter a detected person from an area around a building 130, environment 100, and/or object. The speaker(s) 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller (e.g., user interface 119) may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101, one or more security devices, and/or the speaker 116 may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer 120 may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101, one or more security devices, and/or the speaker 116, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101, one or more security devices, and/or the speaker 116 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101, one or more security devices, and/or the speaker 116 may play a primary sound layered and/or overlapping with one or more secondary, tertiary, and/or background sounds, varying the sounds and/or the combination from one or more previously played sounds and/or combinations, or the like.

The security system 101, one or more security devices, and/or the speaker 116, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101, one or more security devices, and/or the speaker 116, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101, one or more security devices, and/or the speaker 116 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101, one or more security devices, and/or the speaker 116 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101, one or more security devices, and/or the speaker 116 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

### MONITORING DISPATCH NOTIFICATION

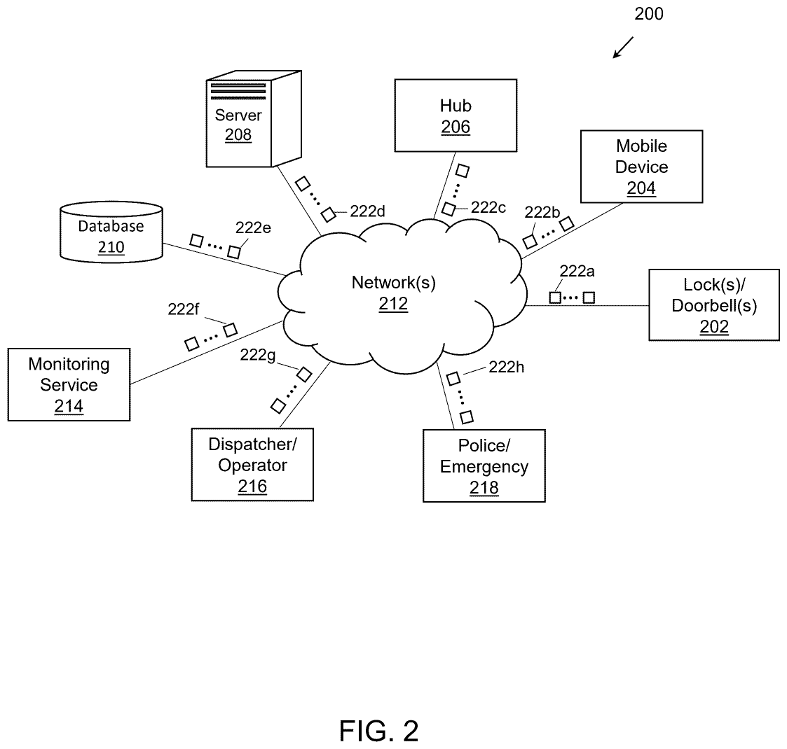

Turning now to FIG. 2, a network environment 200 inclusive of a home security system (e.g., hub) at a residence, monitoring service in communication with the home security system of the residence, and emergency services with which the monitoring service may communicate in the event of an emergency event being reported to the monitoring service are shown, according to an embodiment. One or more elements of the network environment 200 may be located partially or entirely within the enclosed space (e.g., any building, edifice, or enclosure including one or more walls and one or more entrances). The network environment 200 may include one or more smart lock(s)/doorbell(s) 202. The network environment 200 may further include a mobile device 204 (e.g., a smartphone) of a user and a hub 206 located internal and/or external from the space. Further, the network environment 200 may include a server 208 (e.g., a cloud server), a database 210, and one or more networks 212 (e.g., a local network may be part of the network environment 200 provided by the security system). The network environment 200 may further include a monitoring service 214, a dispatcher/operator 216, and a police/emergency authority 218. The various devices and components of the network environment 200 may communicate with one another via the one or more networks 212 and via the signals 222a-222i, as further described herein.

The lock(s)/doorbell(s) 202 may be any type of electronic device including hardware components (e.g., one or more processors, non-transitory memory, user interface, housing, etc.) and software components capable of performing the various processes and tasks described herein. The lock(s)/doorbell(s) 202 may include an electronic display, one or more indicators, a user input, a communication module, a lock engagement member, a physical housing, one or more sensors (e.g., cameras, proximity sensors, radar, sonar, infrared, etc.), and/or more, as further described herein.

In an embodiment, one or more of the lock(s)/doorbell(s) 202 may function for reporting and handling emergency events (e.g., a house fire, break-in, heart attack, etc.) to a central device (e.g., hub 206) or a non-central device (e.g., mobile device 204) for use in reporting to a monitoring service. In an alternative embodiment, the lock(s)/doorbell(s) 202 may communicate with the monitoring service 214. Further, the lock(s)/doorbell(s) 202 may further be configured to optionally communicate (e.g., with cloud server 208, etc.) in the event that the notification to the central device or to a mobile device (e.g., a cell phone of a user, such as mobile device 204) is not responded to, dismissed, or viewed within a certain time period (e.g., a predefined time period associated with a user preference and/or alarm system setting). As described above, the lock(s)/doorbell(s) 202 may include an electronic display (e.g., LCD screen) configured to display information to a user and/or receive input from the user to transmit to the other components of FIG. 2.

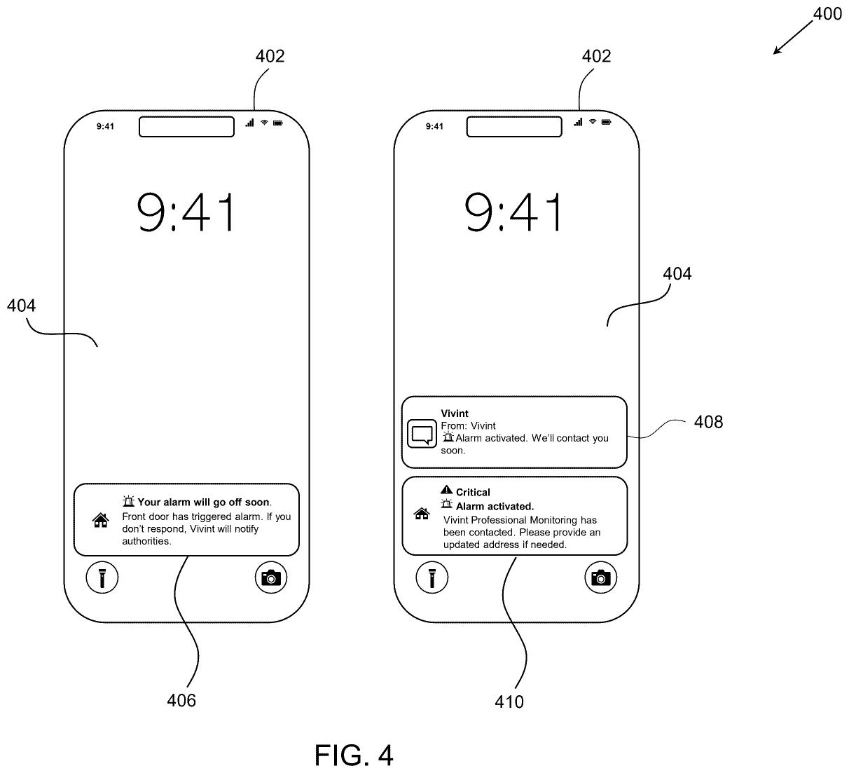

The user device 204 (e.g., a mobile electronic device or mobile device, such as a smartphone) may be any type of electronic device comprising hardware components (e.g., one or more processors, non-transitory storage medium, electronic display configured to support an interactive user interface) and software components capable of performing the various processes and tasks described herein. By way of example, the user device 204 is distinct from the user interface of FIG. 1, however, the user device 204 may be the same user interface 119 of FIG. 1, in which case the description is incorporated herein. Non-limiting examples of the user device 204 include personal computers (e.g., laptop computers, desktop computers), server computers, mobile devices (e.g., smartphones, tablets), VR devices, and gaming consoles, smart watches, among other types of electronic devices. In an illustrative embodiment, the user device 204 is a mobile electronic device (e.g., smartphone) executing one or more mobile applications or app(s) that are configured to communicate with (e.g., transmit to and receive from) the various components of the network environment 200. The user device 204 may include an electronic display (e.g., LCD screen) for displaying a user interface (e.g., as shown on FIGS. 4-7), communication electronics (e.g., for communicating via the network 212), and/or a physical housing.

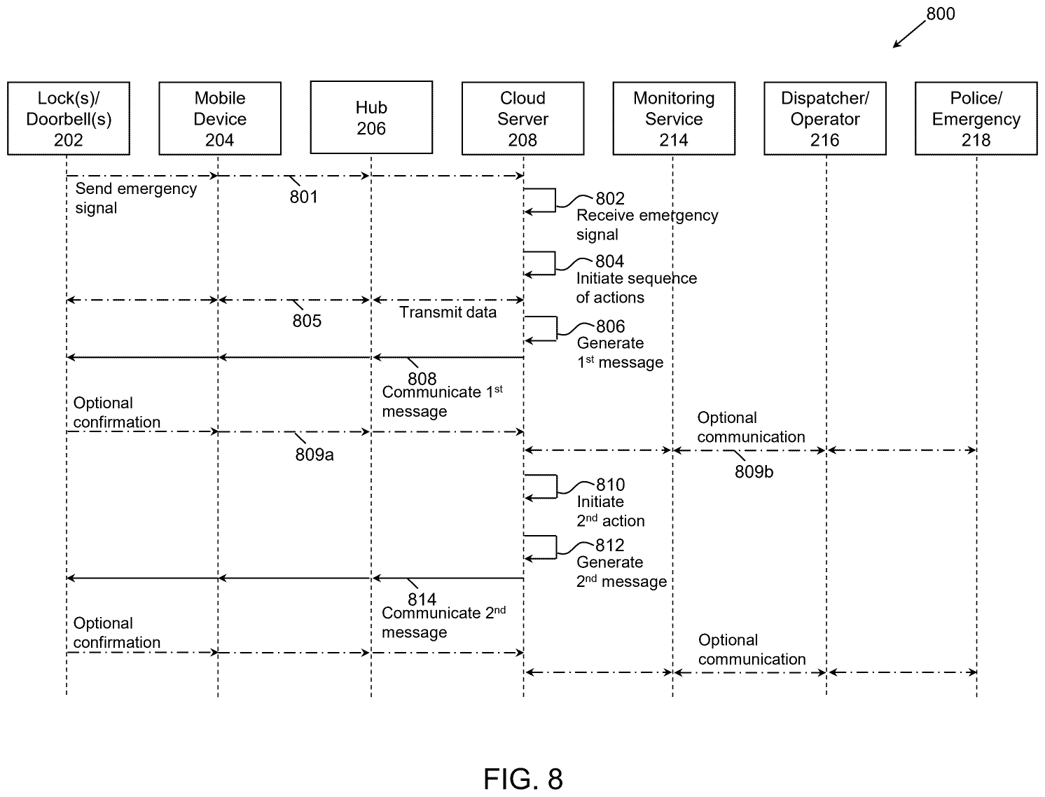

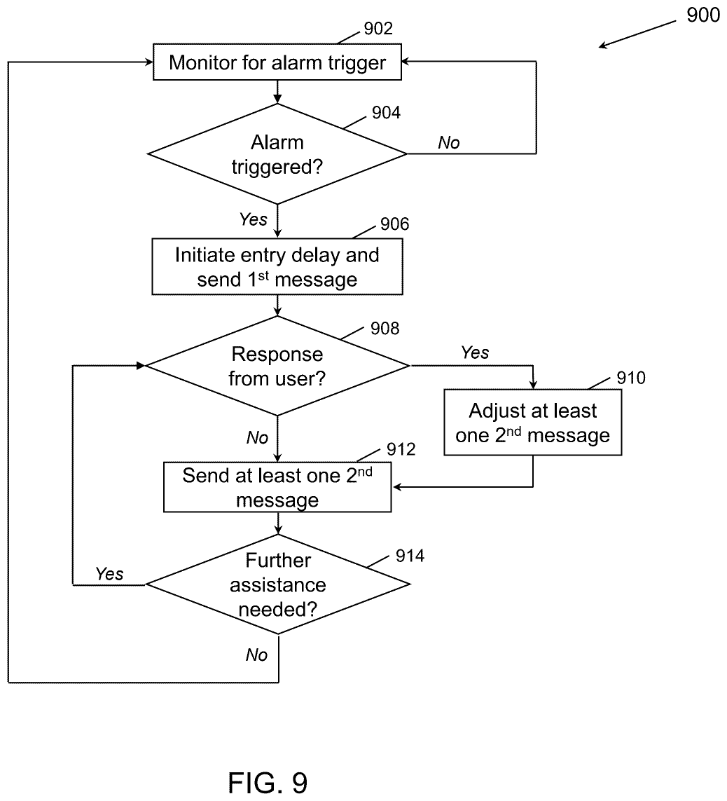

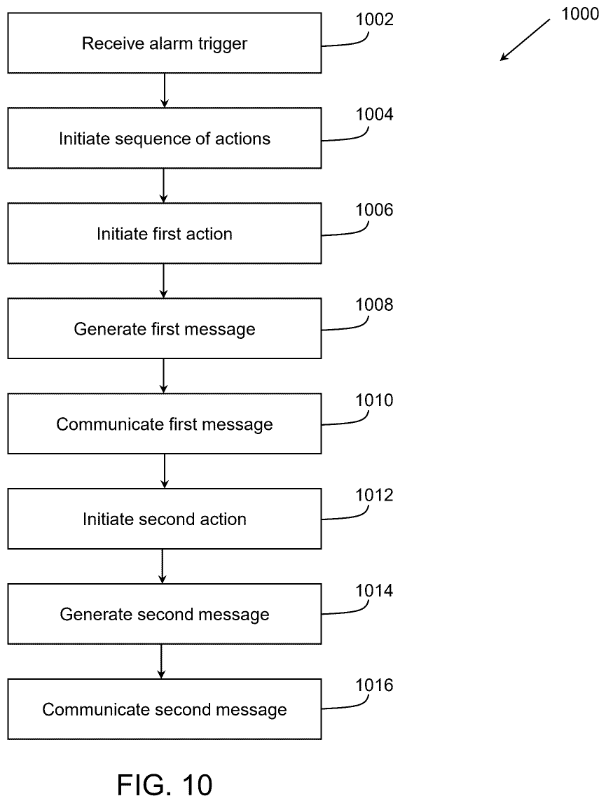

The user device 204 may include one or more computing devices configured to execute one or more software programs (e.g., mobile applications or apps) to perform various processes (e.g., the process 800 of FIG. 8, the process 900 of FIG. 9, and/or the process 1000 of FIG. 10). In some embodiments, the user device 204 may be a computer or computing device capable of performing the same or similar methods disclosed herein as performed by the user device 204. The user device 204 may include a processor and non-transitory, computer-readable medium including instructions, which, when executed by the processor, causes the processor to perform methods disclosed herein. Although FIG. 2 shows only a single user device 204, any number of devices associated with one or more users may be configured in the same or similar manner. In some cases, the computing devices of the user device 204 may perform all or portions of the processes of the lock(s)/doorbell(s) 202, the hub 206, and/or the cloud server 208.

By way of example, the user of the network environment 200 may interact with the user device 204 to receive and/or provide information related to one or more actions in the sequence of actions being performed to protect a user of the alarm system. For example, in response to a reported emergency event (e.g., reported via the lock(s)/doorbell(s) 202, mobile device 204, hub 206, etc.), the mobile device 204 may be configured to receive and provide notifications and/or messages (e.g., push notifications, SMS messages, etc.) for display to the user. For example, as described in detail below, the mobile device 204 may be configured to receive and provide (e.g., via an electronic display) a sequence of notifications, each notification in the sequence of notifications corresponding to an action performed in a sequence of actions to protect the user of the alarm system.

The hub 206 may be configured to perform functions similar to, or the same as, the controller 106 of FIG. 1, as previously described. For example, the hub 206 may include one or more processors that execute one or more software programs to perform various processes (e.g., the process 800 of FIG. 8, the process 900 of FIG. 9, and/or the process 1000 of FIG. 10) and a non-transitory, computer readable medium including instructions, which, when executed by the processor(s), cause the processor(s) to perform methods disclosed herein. The hub 206 may be communicatively coupled with the various components of the network environment 200 and/or other smart devices of the building directly or indirectly (e.g., through the network(s) 212, as shown in FIG. 2). By way of example, the hub 206 may receive control signals from, and transmit the control signals to, the lock(s)/doorbell(s) 202, the mobile device 204, the server 208, and other components of the network environment 200. The hub 206 may be further configured to receive various communication protocol signals and translate the various communication protocol signals into control signals to control the various components of the network environment 200. In some embodiments, the hub 206 can receive and/or transmit information related to the action in the sequence of actions being performed to protect the user (e.g., by transmitting alarm state information to the cloud server 208, by receiving user input from lock(s)/doorbell(s) 202 and transmitting the user input to the cloud server 208, etc.) or directly perform one or more actions in the sequence of actions.

The server 208 (e.g., cloud-based server) may include one or more processors that execute one or more software programs to perform various processes (e.g., the process 800 of FIG. 8, the process 900 of FIG. 9, and/or the process 1000 of FIG. 10) and a non-transitory, computer readable medium including instructions, which, when executed by the processor(s), cause the processor(s) to perform methods disclosed herein. Although FIG. 2 shows only a single server 208, the server 208 may include any number of computing devices. In some cases, the computing devices of the server 208 may perform all or portions of the processes described herein to support the network environment 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the lock(s)/doorbell(s) 202 or any other component (e.g., mobile device 204, hub 206) of the network environment 200.

The cloud server 208 may perform various actions (e.g., itself or via various components of FIG. 2) related to protecting the user of the alarm system. For example, the cloud server 208 may initiate and/or perform one or more actions in a sequence of actions in response to an emergency event being reported, and the cloud server 208 may further communicate information related to the action as a notification to the mobile device 204. The sequence of actions is described in greater detail herein.

For ease of description and understanding, FIG. 2 depicts the network environment 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the lock/doorbell 202 through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The network environment 200 may include or utilize one or more networks 212, which may include any number of internal networks (e.g., LANs), external networks (e.g., WANs), private networks (e.g., intranets, VPNs), and public networks (e.g., Internet). The network(s) 212 may include various hardware and software components for hosting and conducting communications amongst the components of the network environment 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

The network environment 200 may further include an event center or monitoring service 214. The monitoring service 214 may be a residential security monitoring service, commercial security monitoring service, emergency response service, law enforcement liaison service, home automation control center, third-party monitoring platform, government agency, emergency event center, central event dispatcher, or otherwise. For example, the monitoring service may be commercial emergency event center associated and integrated with the smart lock system (e.g., internal/dedicated monitoring service, third-party monitoring service hired to assist users of the smart lock system, etc.). In another example, the monitoring service 214 may be an emergency telecommunications dispatcher or a central event dispatcher (e.g. 911 operator). The monitoring service 214 may receive and utilize information for a variety of uses including determining whether an emergency event exists, the type of emergency event (e.g., category, device identifier of device used for reporting), whether to contact public authorities (e.g., police), verifying that a person is a specific person (e.g., an authorized user, on a blacklist, etc.), and so on.

The dispatcher/operator 216 may be a person or automated system (e.g., interactive voice recognition system optionally with an artificial intelligence feature for added capabilities) tasked with the coordination and management of responses to emergency events as relayed by the monitoring service 214. For instance, the dispatcher/operator 216 can function as a central command center for emergency services, a dedicated 911 operator, or a specialized dispatcher for distinct types of emergencies, including fire, medical, or police incidents. Additionally, the dispatcher/operator 216 may evaluate the nature and severity of emergencies reported and determine the most suitable emergency services to deploy (e.g., whether to contact one or more of fire, medical, or police services). The dispatcher/operator 216 can further provide immediate guidance or instructions to individuals reporting the incident (e.g., information associated with the user, such as home address; information associated with the emergency event, such as event type or triggering device; other information for various uses, such as the number of reported emergencies associated with the user; etc.). As such, the dispatcher/operator 216 can serve as an intermediary between the monitoring service 214 and one more police/emergency authorities 218 as described below. For example, the dispatcher/operator 216 can receive the initial emergency report from the monitoring service 214, perform activities (e.g. triage, etc.), and further transmit information associated with the reported emergency to one or more emergency authorities (e.g., police/emergency authority 218).

The network environment 200 may also include a police/emergency authority 218. The police/emergency authority 218 may be one or more entities related to or tasked with responding to an emergency event, such as a public authority, private entity (e.g., private security company), volunteer organization, specialized emergency service, and/or more. Further, the police/emergency authority 218 may correspond to a specific category of emergency (e.g., local fire department tasked with addressing fire outbreaks and conducting rescue operations in such scenarios (e.g., building fires, smoke, etc.), local police department responsible for maintaining public order, ensuring safety, and responding to criminal incidents (e.g., home break-in, theft, etc.), Emergency Medical Services (EMS) agency or other entity related to or assigned to handle health events (e.g., heart attacks, strokes, etc.), etc.). One or more components of the network environment 200 (e.g., server 208, monitoring service 214, etc.) may transmit information to the police/emergency authority 218 in response to receiving a signal indicative of an emergency event being experienced by the user or related to a space secured by a smart home system of the user.

Control and informational signals may be transmitted between the components of the network environment 200. For example, the signals 222a-222i (collectively 222) may be transmitted between and amongst components through the network(s) 212. As described herein, the signals 222 may be transmitted utilizing any suitable communication protocol. According to illustrative embodiments, the signals 222 may be transmitted directly between components of the network environment 200. Additionally and/or alternatively, the signals 222 may be transmitted from a component of the network environment 200 (e.g., mobile device 204) in response to a user performing an action (e.g., reporting an emergency event, reporting a lack of need for assistance, etc.). Further, the signals 222 may be transmitted from a first component of the network environment 200 to a second component (e.g., the hub 206) and then relayed from the second component to one or more other components of the network environment 200 (e.g., server 208, police/emergency authority 218, etc.).

In some embodiments, the sequence of actions can include various steps, methods, processes, and/or phases, which may be related to the alarm activation, to the user/the user's protected environment (e.g., user's home), or to the various components of FIG. 2 (e.g. lock(s)/doorbell(s) 202, mobile device 204, hub 206, etc.), which are described in detail herein. For example, the sequence of actions may include a number of predefined steps (e.g., stages) to be performed (e.g., by the cloud server 208) in order, to be performed in a modified order depending on user input received during the performance of the one or more actions (e.g., skipping one or more steps, advancing or escalating to a step other than the next consecutive step, etc.), or otherwise.

For example, a first action in the sequence of actions can include monitoring for an alarm trigger, receiving an alarm trigger, and/or informing a user that a response to a message may be submitted to prevent a monitoring service from notifying authorities. Further, the first action may occur during a delay period (e.g., 30 seconds, 1 minute, etc.) associated with the alarm system during which the alarm has been triggered (e.g., detected unauthorized entry, outputting an audible “warning” signal at a reduced volume relative to an audio signal output after the delay period, etc.), but has not been fully activated (e.g., monitoring service 214 has not been contacted, monitoring service has been contacted, but has not contacted the dispatcher/operator 216 or the police/emergency authorities 218, etc.). For example, the delay period may be a thirty-second time period during which (i) an alarm has been triggered, (ii) a smart home device (e.g., lock(s)/doorbell(s) 202 and/or hub 206) is outputting a reduced-volume audio signal, and (iii) the cloud server 208 has received a signal corresponding to the alarm trigger and has prompted the user to respond (e.g., via a communication to mobile device 204) before notifying an emergency operator or authorities (e.g., operator/dispatcher 216, police/emergency authority 218). In some embodiments, the user may receive a notification corresponding to the first action in the sequence of actions (e.g., via the cloud server 208 transmitting information associated with the first action to the mobile device 204).

Continuing this example, a second action in the sequence of actions may include further activating or fully activating the alarm that was previously triggered (e.g., to output audio at a full volume associated with an official alarm activation) and/or performing further actions associated with an alarm activation (e.g., transitioning a mobile app to be in and out of an alarm state, transitioning one or more smartphone devices to be in the alarm state, etc.). In some embodiments, the performance of the second action (and other subsequent actions in the sequence of actions) may depend on user input received while the sequence of actions is being performed. For example, if the user does not respond or provide input via the first notification associated with the first action, the second action may be performed (e.g., further escalating the reported emergency event). However, if the user responds and indicates assistance is not needed (e.g., responding that the alarm is a “false alarm,” that emergency has ended, that authorities have already arrived, etc.), the second action may not be performed, performance of the second action may be delayed, etc. In some embodiments, the performance of one or more second actions following the initial second action (e.g., a third action, fourth action, fifth action, etc.) may be adjusted in response to user input (e.g., omitted, skipped, reordered, etc.), as described above regarding the second action. In some embodiments, the user may receive a notification corresponding to the second action in the sequence of actions (e.g., via the cloud server 208 transmitting information associated with the second action to the mobile device 204).

Further, a third action in the sequence of actions performed to protect the user of the alarm system may include notifying a monitoring service/authorities (e.g., monitoring service 214, operator/dispatcher 216, and/or police/emergency authorities 218) of the emergency event and/or prompting the user to provide additional information for further use by the monitoring service/other authorities. For example, if the user has not provided input indicating that assistance is not required, the alarm system (e.g., via cloud server 208) may connect the user with a monitoring service (e.g., third party monitoring service, event center associated with smart home/alarm system, etc.) and provide the monitoring service with information associated with the user, the alarm system, and/or the reported emergency event (e.g., device used for reporting, emergency event type, user's name/home address/emergency contacts, etc.). In some embodiments, the fourth action includes prompting the user to provide additional and/or updated information (e.g., updated address, phone number, additional emergency event details, etc.), which may be further utilized by the monitoring service in performing the subsequent actions described below. In some embodiments, the user may receive a notification corresponding to the third action in the sequence of actions (e.g., via the cloud server 208 transmitting information associated with the third action to the mobile device 204) for providing additional and/or updated information. The additional and/or updated information may auto-populate by accessing a data repository or be populated by the mobile device 204 enabling the user to type into a text field via a virtual keypad or using voice recognition.

Continuing this example, the fourth action in the sequence of actions may include the monitoring service (e.g., monitoring service 214 associated with the user and/or the smart home/alarm system of the user) or the alarm system itself (e.g., via the cloud server 208, etc.) attempting to contact the user. For example, the third action can include a monitoring service placing a series of phone calls to the mobile device of the user, sending a series of SMS messages to the mobile device of the user, sending a series of messages and/or communications to the hub/doorbells/door locks to prompt user response, etc. In some embodiments, the third action can include the monitoring service attempting to contact the user directly (e.g., by the monitoring service placing a direct phone call to a mobile device associated with the user). Further, the third action can include the monitoring service attempting to contact one or more listed emergency contacts of the user of the smart system (e.g., by phone, SMS, push notification, etc.). For example, the alarm system may access information associated with emergency contacts of the user (e.g., family members, spouses, close friends, roommates, etc.) and attempt to contact one or more emergency contacts to determine whether assistance/further escalation associated with the emergency event is needed (e.g., whether a fifth, sixth, etc. step is to be performed). If the alarm system successfully communicates with the user or an emergency contact who confirms assistance is not required (e.g., confirms the reported emergency event is a false alarm), the alarm system may not perform subsequent actions, as described above regarding the performance of the second action. However, if the monitoring service/alarm system does not successfully communicate with the user and/or receives information from the user indicating a need for emergency services (e.g., a user requiring police presence, an ambulance, etc.), further actions may be performed as described below. In some embodiments, the user may receive a notification corresponding to the fourth action in the sequence of actions (e.g., via the cloud server 208 transmitting information associated with the fourth action to the mobile device 204).

Continuing this example, if the alarm system does not receive an indication from the user/a user's emergency contact that assistance is no longer required during the performance of the fourth action/via the fourth notification, a fifth action in the sequence of actions may be performed. For example, the fifth action may include the monitoring service contacting an operator (e.g., dispatcher/operator 216) and/or authorities (e.g., police/emergency 218) for further assistance related to the emergency event. In some embodiments, the monitoring service may contact the dispatcher/operator 216 and the dispatcher/operator may then communicate directly with the police/emergency authority 218. In other embodiments, the monitoring service may contact the police/emergency authority 218 directly. In some embodiments, the user may receive a notification corresponding to the fifth action in the sequence of actions (e.g., via the cloud server 208 transmitting information associated with the fifth action to the mobile device 204 that police/authorities have been dispatched to a location associated with the user/smart home system of the user).

In some embodiments, various additional actions may be included in the sequence of actions (e.g., performed by the cloud server 208). For example, a sixth action can include the monitoring service informing the user that police have been dispatched to the user's location or to the alarm trigger location (e.g., the space secured by the user's smart lock system). Another action can include monitoring for the alarm to be deactivated, notifying the user in response to receive information indicative of the alarm being deactivated, and prompting the user to provide additional input if further assistance is required. Another action can include determining whether a device used to trigger the alarm (e.g., to report the emergency event to the cloud server 208) is co-located (e.g., within the same space secured by the smart lock system) with a device of the user (e.g., mobile device 204) and, if co-located, updating a follow-up notification, message, and/or action; determining that a notification address associated with the alarm trigger is a network address associated with the user; and/or generating and communicating the follow-up message to the user via the network (e.g., network 212). Further, another action can include determining whether a device used to trigger the alarm is not co-located with a device of the user and, if not co-located, enabling the user to submit an address and/or other information that would be helpful for the dispatcher.

While examples are described above, various additional and/or alternative actions may be performed/included in the sequence of actions to protect the user of the alarm system. For example, the sequence of actions may include additional unrecited actions (e.g., preparation actions in advance of listed actions, etc.), may omit certain actions entirely in some embodiments, may perform actions in an alternative order, etc. Data associated with one or more actions and/or the sequence of actions (e.g., list of actions, order of performance, instructions for performance, etc.) may be stored using the various devices of FIG. 2 (e.g., lock(s)/doorbell(s) 202, mobile device 204, hub 206, database 210, etc.) and further accessed (e.g., via the cloud server 208) for performing and/or notifying the user of the action in the sequence of actions to protect the user. For example, geographic data can be transmitted by the mobile device 204 for use in determining whether a user device is co-located with the device used to trigger the alarm, as described above.

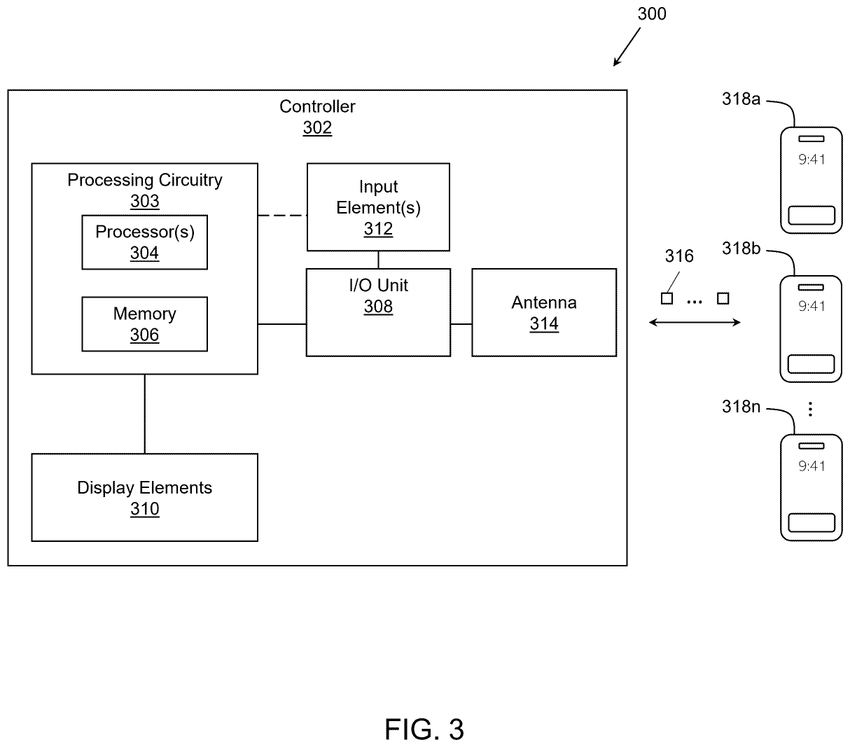

Turning now to FIG. 3, a block diagram of illustrative circuitry 300 of a controller 302 is shown. In some embodiments, the controller 302 may be configured for use in controlling and operating an alarm system that may also include one or more smart locks positioned on or about a space enclosed by one or more walls with at least one entrance, fire alarm sensor, radon sensor, carbon monoxide sensor, etc. In other embodiments, the controller 302 may be configured to receive and/or transmit signals associated with an emergency event, such as a fire alarm. The circuitry 300 may be formed of multiple electronic circuits and modules, including processing circuitry 303 including one or more processors 304 and a memory 306, an input/output unit 308, one or more display elements 310, input element(s) 312, antenna(s) 314 for communicating signals 316 (e.g., communication signals, control signals, data signals, etc.) over one or more frequency bands and using one or more different communication protocols, and so on. The processor(s) 304 may general processors, image processors, digital signal processors, application specific integrated circuits, and/or otherwise configured to execute software to manage operations of the processing circuitry 303 for communicating with and operating the smart lock(s). It should be understood that other components, such as camera(s) speaker(s), illumination devices(s), biometric sensors, motion sensor(s), range sensor(s), or otherwise may be integrated into the controller 302 and be supported by the processing circuitry 303, software being executed thereby, and/or other electronic components. The circuitry 300 may be integrated with any of the lock(s)/doorbell(s) 202, the mobile device 204, the hub 206, and/or the cloud server 208 of FIG. 2. The circuitry 300 may be used to execute/perform various methods and processes (e.g., the process 800 of FIG. 8, the process 900 of FIG. 9, and/or the process 1000 of FIG. 10), as further described herein.

In some embodiments, the controller 302 may be integrated with a physical hub of the alarm system of the user (e.g., hub 206) and the circuitry 300 may further include one or more mobile devices 316 (e.g., one or more of mobile device 204 of FIG. 2). In some embodiments, the controller 302 and mobile device 316 may be at the same location (e.g., being co-located), and in other embodiments, the controller 302 may be located at a different location from the mobile devices 316 (e.g., not being co-located). As used herein, being “co-located” refers to the triggering device and the mobile device of the user being within the same space secured by the smart lock system, separated but within a predefined range (e.g., 100 feet), and/or otherwise within close physical proximity. For example, in response to an alarm being triggered by a device (e.g., in response to a reported emergency event), the controller 302 (e.g., hub 206) may transmit a signal to a server (e.g., cloud server 208) including geographic data from the mobile devices 316 (e.g., GPS information, cell ID information, Wi-Fi-access point data, Bluetooth beacon data, satellite data, timestamp data, etc.) and geographic data (e.g., GPS information, etc.) from device used to trigger the alarm. Further, the geographic data transmitted by the controller 302 can be used to determine whether the triggering device is within a predetermined range of the user device (e.g., to determine whether the devices are co-located or not co-located). In some embodiments, different messages may be sent depending on whether the user is at home or not at home (e.g., at work).

With regard to FIG. 4, an illustrative system 400 including an electronic device 402 used for providing monitoring dispatch notifications is shown, according to an embodiment. As shown, the electronic device 402 may include an electronic display 404. The electronic display 404 may be configured to display a series of messages to a user in response to receiving an alarm trigger from an alarm system being used to monitor a location (e.g., residence).

For example, as shown in FIG. 4, the electronic device 402 may display a first message 406 to a user. The first message 406 may include information to inform the user of the electronic device 402 of various actions in a sequence of actions being performed to protect the user of the alarm system. For example, the first message 406 may include a header (e.g., a short description of the action in the sequence of actions such as “Your alarm will go off soon”) and a body (e.g., longer description to give the user additional context related to the action and the sequence of actions such as, “Front door has triggered alarm. If you don't respond, Vivint will notify authorities”). Further, the first message 406 may include icons, symbols, emojis, and/or other illustrations, and the icons/other illustrations may correspond to the action of the sequence of actions (e.g., may provide users with a visual indicator or representation associated with the action). For example, the first message 406 relates to an alarm of the alarm system being activated and includes an icon of a siren/alarm (e.g., to provide a visual indicator for quick reference by the user viewing the electronic device 402). In some embodiments, the first message 406 may be sent in response to the alarm system being activated to generate an alarm. The first message 406 may be transmitted to the electronic device 402 via a network including various smart home devices and computing elements (e.g., hub 206, server 208, database 210, etc., as described regarding a FIGS. 1-2). In some embodiments, the first message 406 may correspond to a first action in the sequence of actions, such as described regarding FIG. 2 (e.g., may provide the user with information related to the first action, prompt user response related to the first action, etc.).

Continuing with FIG. 4, the electronic device 402 can receive and display a second message 408. As described regarding the first message 406, the second message 408 may include information to inform the user of the electronic device 402 of various actions in the sequence of actions being performed to protect the user. As shown, the second message 408 may also include a header and body. Further, the second message 408 may be configured to provide the user with information relating to the status of a monitoring service's response concerning any emergency event reported by the user. Again, as described regarding the first message 406, the second message 408 may include icons, emojis, illustrations, etc. to inform the user of the current action being taken (e.g., by a monitoring service, by emergency services dispatcher, by authorities, etc.) to protect the user. In some embodiments, the second message 408 may correspond to a second action in the sequence of actions, such as described regarding FIG. 2 (e.g., may inform the user that an alarm has been activated and/or that a monitoring service/authorities will be contacted).

Still referring to FIG. 4, the electronic device 402 can receive and/or provide a third message 410 to the user (e.g., via the electronic display 404). As shown, the third message 410 can be a “critical” message or notification that bypasses a security function of the electronic device/mobile device 402. For example, critical notifications can be received/appear on the home screen of a user's electronic device, similar to normal push notifications, but in contrast to standard push notifications, the message/notification may still be received/appear on the home screen of a user's electronic device even if the electronic device is in a “silenced” and/or “do not disturb” mode (e.g., implementing security functions). In some embodiments, the third message 410 may include a distinct sound, haptic, and/or visual notification that differs from a sound, haptic and/or visual notification accompanying a non-critical message (e.g., first message 406, second message 408, etc.). For example, as shown on FIG. 4, the third message 410 may include a “caution” icon to inform the user of the electronic device 402 that the third message 410 is a critical message. In some embodiments, if a user receives multiple messages/notification from/related to the alarm system via the electronic device 402, the messages may be nested, rearranged, or otherwise organized to allow the user to view a current message and information related to past messages on the same screen. In some embodiments, the third message 410 may correspond to a third action in the sequence of actions, such as described regarding FIG. 2 (e.g., informing the user that a monitoring service has been contacted regarding the emergency event).

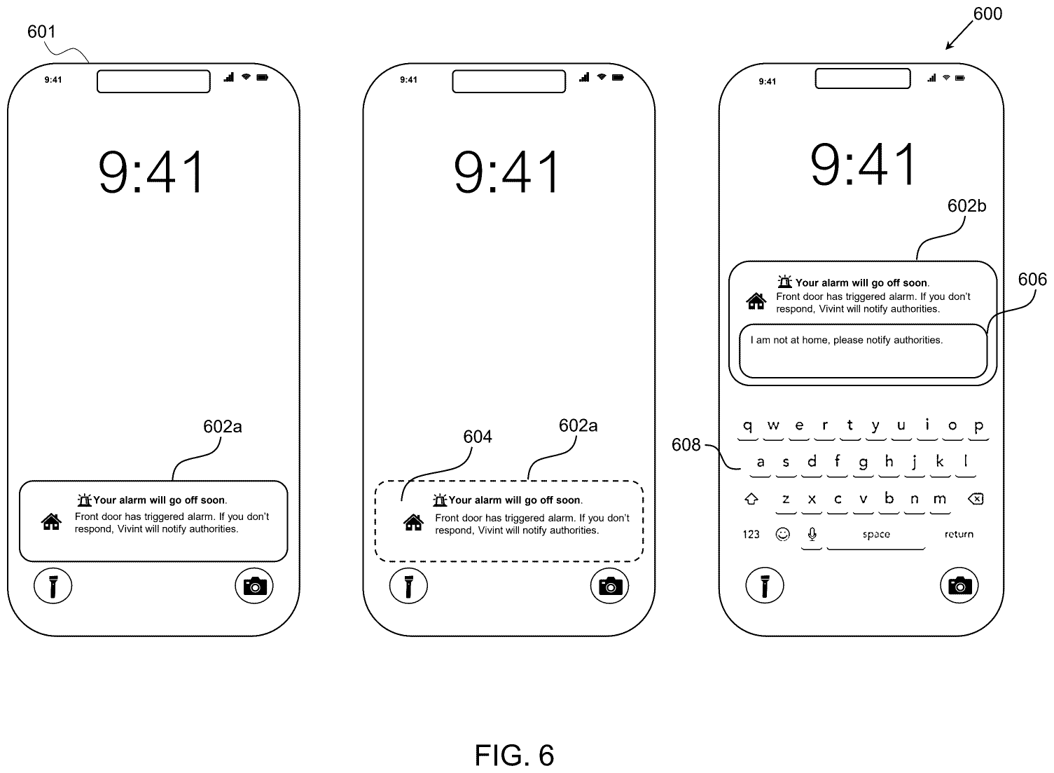

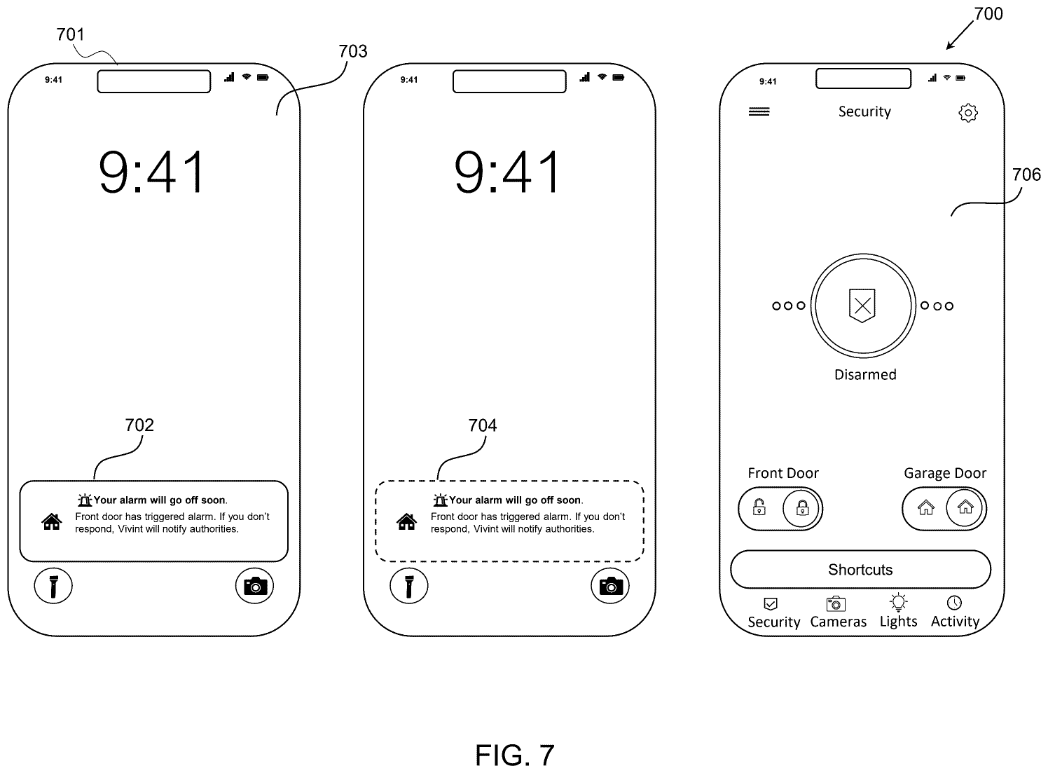

Further, both standard notifications (e.g., first message 406, second message 408) and critical notifications (e.g., third message 410) may be configured to enable user-interaction (e.g., may allow the user to interact with the message, such as to provide additional information for use in the emergency event response). In some embodiments, as described regarding FIGS. 6-7, the messages transmitted via the electronic device 402 may be user-interactive such that a user can click, press, hold, and/or otherwise interact with the messages (e.g., first message 406, second message 408, third message 410) using a predetermined gesture. For example, in response to the predetermined gesture of the user holding a button or other feature (e.g., message 406) displayed on a user interface (e.g., electronic display 404) for an extended period of time, subsequent actions in the sequence of actions and/or notifications related to the actions may be updated.

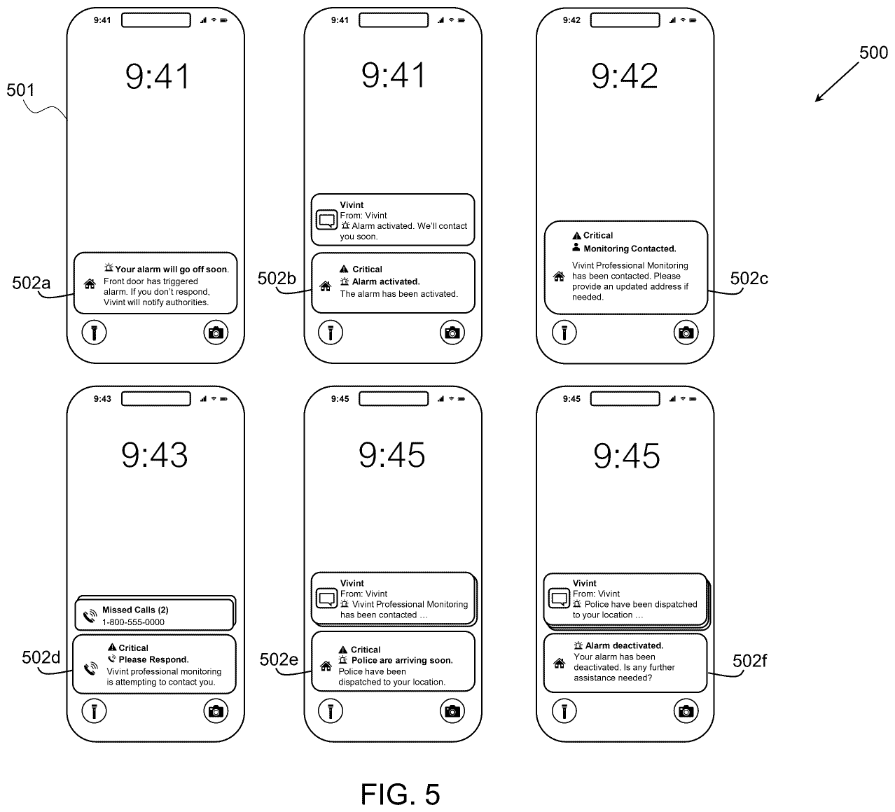

With regard to FIG. 5, an illustrative system 500 including an electronic device 501 for receiving monitoring dispatch notifications 502a-502f (collectively 502) is shown, according to an embodiment. As shown each of the notifications (or messages) 502 may correspond to one or more actions in a series (or sequence) of actions being performed to protect the user of the alarm system in response to the user or the alarm system reporting an emergency event (e.g., fire, health event, break-in, theft, etc.). The sequence of actions (e.g., performed by cloud server 208 of FIG. 2, etc.) can include various steps, methods, processes, and/or phases, which may be related to the alarm activation, to the user/the user's protected environment (e.g., user's home), or to the various components of FIG. 2 (e.g. lock(s)/doorbell(s) 202, mobile device 204, hub 206, etc.). For example, the first message 502a may correspond to the first action as described regarding FIG. 2, the second message 502b may correspond to the second action as described regarding FIG. 2, and so on. In some embodiments, the messages 502 may correspond to additional/alternative actions or sequences of actions other than the illustrative embodiment described regarding FIG. 2.

Still referring to FIG. 5, a user can receive a first message 502a. As described above, the first message 502a can be a push notification received via the electronic device 501 (e.g., a smartphone) of a user of an alarm system and be designed to inform the user of the alarm system of one or more actions being taken in a sequence of actions to protect the user. For example, the first message 502a may inform the user that an alarm of the user's smart home system has been triggered and that, absent user response, a home security company/monitoring service will notify authorities. In some embodiments, the first message may be sent in response to a first action of the sequence of actions being initiated and/or performed.

Continuing with the discussion of FIG. 5, the user may receive a second message 502b. In some embodiments, the second message 502b may be sent in response to a second action of the sequence of actions being initiated. Further, as described above regarding FIG. 4 and third message 410, the second message 502b may be sent/received as a critical notification that bypasses a security function of the electronic device of the user. Further, the second message 502b may include information (e.g., icons/emojis/illustrations, headers/bodies, other texts/illustrations, etc.) to inform the user of the second action in a sequence of actions being taken to protect the user. For example, the second message 502b can be a critical message and inform the user that the alarm system being used to monitor a location (e.g., residence) of the user has been activated (e.g., triggered). As described above regarding FIG. 4, prior message(s) sent to the user regarding prior actions in the sequence of action may be collapsed, reorganized, and/or rearranged to direct the user's focus to the current message (e.g., second message 502b) corresponding to the current action and to simultaneously allow the user to view, access, and/or respond to information received via a previous message (e.g., first message 502a).

Further, the user may receive a third message 502c, which may include information to inform the user of actions being taken to protect the user and or be sent/received as a critical message, as described above. As shown, the third message 502c may include information that prompts, requests, or suggests that the user perform some action or provide some information related to the notification and/or the emergency event. For example, the third message 502c may include text informing the user that a professional monitoring service has been contacted. In some embodiments, the third message 502c may include text prompting or requesting the user to provide an updated address for dispatch if the user address known to the monitoring service/home security system is inaccurate, outdated, or otherwise needs updating. The third message 502c may be a user-interactive message configured to enable a user to interact and provide additional information using the message, as described in detail regarding FIG. 6.

Further, the user may receive a fourth message 502d. In some embodiments, the fourth message 502d may be sent in response to another action (e.g., fourth action) being performed to protect the user of the alarm system. For example, if the monitoring service attempted to contact the user (e.g., call via telephone, send SMS, email, etc.) but was unsuccessful (e.g., user device showing missed calls from the monitoring service), the fourth message 502d may include information to inform the user that the monitoring service was attempting to contact the user and/or suggested steps (e.g., responding to the phone call) for the user to take during the emergency event. In some embodiments, as described above, the fourth message 502d may be a critical message that bypasses a security function of the mobile device of the user (e.g., a function preventing a message from appearing on a display of a user's electronic device while a setting of the electronic device is set to a specific mode, such as “do not disturb” mode).

Still referring to FIG. 5, the user may receive a fifth message 502e (e.g., via the electronic device 501). In some embodiments, the fifth message 502e may correspond to a further action taken in the sequence of actions to protect the user of the alarm system (e.g., the fifth action as described regarding FIG. 2). For example, the fifth message 502e may include information to inform the user that police/authorities have been dispatched to the user's location and/or will be arriving soon. Further, in response to the alarm being deactivated (or the user otherwise communicating to the monitoring service a lack of need for assistance), a sixth message 502f may be received by the user. For example, the sixth message 502f may include information to inform the user that the user's alarm has been deactivated. Further, the sixth message 502f may include a prompt or request for user input (e.g., “Is any further assistance needed?”), and the user may interact with the sixth message 502f to provide information to the monitoring service/authorities, as described in detail below regarding FIG. 6. While examples are shown above, various other messages may be transmitted to/received by the electronic device 501 corresponding to additional and/or alternatives actions or sequences of actions being performed to protect the user.

With regard to FIG. 6, an illustrative system 600 for responding to notifications via an electronic device 601 is shown, according to some embodiments. As described above, a user may receive a message (e.g., first message) 602a corresponding to an action taken in a sequence of actions to protect the user, which may include information informing the user of the actions taken (e.g., “Front door has triggered alarm,” “If you don't respond, Vivint will notify authorities,” etc.). The message 602a may be a user-interactive message configured to allow a user to provide additional information to be used in subsequent notifications via the message 602a. In some embodiments, the user can interact with message 602a by, for example, performing a predetermined gesture with respect to the first message 602a. For example, the user may press, hold, click, or otherwise interact with the message 602a such that the first message 602a appears in an interactive state 604. Further, the interactive state 604 may include a first message 602a being highlighted, expanded, or otherwise adjusted to indicate the user's ability to interact with the first message 602a. For example, as shown on FIG. 6, a user may interact with the first message 602a by performing a predetermined gesture (e.g., press-and-hold, deep press, holding a message button for a predetermined time period, etc.) such that the first message 602a appears in the interactive state 604 (e.g., being highlighted or focused on by the electronic device 601).

In response to the user interacting with the first message 602a (e.g., in the interactive state 604), the electronic device 601 may further highlight expand, move, or otherwise adjust its display (e.g., by adjusting a user interface or GUI) to allow the user to provide additional information via the electronic device 601. In some embodiments, in response to the user performing a predetermined gesture as described above, the electronic device 601 may adjust the appearance of the first message 602a to appear as the adjusted first message 602b. For example, the first message 602a may be adjusted to appear as an adjusted first message 602b and the electronic device 601 may further display a content field 606 and/or user input feature 608 in response to the user interacting with the message 602a (e.g., in the interactive state 604). The user input feature 608 may be a keyboard or other user input configured to allow the user to provide information related to the emergency event by using the user input feature (e.g., text entry field or prompt) 608. In some embodiments, this additional information provided by the user may be used (e.g., by the alarm system, by a hub, by a cloud server, etc.) in sending and/or generating subsequent notifications/messages to the user (e.g., to electronic device 601), as further described herein.

With regard to FIG. 7, an illustrative system 700 inclusive of an electronic device 701 for accessing a home security mobile application (e.g., alarm interface) via a monitoring dispatch notification is shown, according to some embodiments. As shown, the electronic device 701 may display a message 702 (e.g., a monitoring dispatch notification on an electronic display 703), and the message 702 may be a user-interactive message such that a user can interact with the message 702 by performing a predetermined gesture (e.g., press and hold, deep press, etc.), causing the message 702 to appear in an interactive state 704. Further, in response to the user performing the predetermined gesture using the message 702 (e.g., while the message 702 is in the interactive state 704), the electronic device 701 may be configured to display an alarm interface 706 of the alarm system of the user (e.g., a mobile application associated with the user's smart lock/alarm system).

As shown, the alarm interface 706 may allow the user to perform various actions related to the emergency event and/or the alarm system, such as disarming the alarm system, opening or closing doors in the space secured by the alarm system, accessing various shortcuts (e.g., related to security, cameras, lights, activity, etc.), accessing settings associated with the alarm interface, and otherwise via a mobile application of the alarm system (e.g., executing on the electronic device 701). Based on the user further interacting with one or more of the various features, tools, buttons, shortcuts, and/or settings included on the alarm interface 706, the system 700 may update or otherwise modify the generation or sending of subsequent messages relating to actions performed in a series of actions to protect the user the alarm system (e.g., by adjusting the content of a subsequent notification sent to the electronic device 701). For example, in response to the alarm interface 706 being displayed based on the user interacting with the message 702 using the predetermined gesture, the user may interact with the alarm interface 706 by disarming the alarm system (e.g., if there is no ongoing emergency, if the user otherwise does not require any assistance the from home security system/monitoring service/dispatchers/authorities, etc.). Further, in response to the user disarming the alarm system via the alarm interface 706, the system may prevent the sending of subsequent notifications based on the determination that assistance is no longer required. While an example is illustrated above, other user input provided via the alarm interface 706 (e.g., user pressing a “lock” button, adjusting a setting, etc.) may be used to adjust the performance of various additional and/or alternative actions of the sequence of actions, or to adjust the generation/sending of various other notifications related to the actions being performed.

With regard to FIG. 8, a “swim-lane” flowchart of an illustrative process 800 for providing or receiving monitoring dispatch notifications is shown, according to some embodiments. The process 800 (e.g., computer-implemented method) may be performed using various computing systems/elements, such as locks/doorbells 202, mobile device 204, hub 206, cloud server 208, monitoring service 214, dispatcher/operator 216, and/or police/emergency authority 218 (e.g., as described regarding FIG. 2).

In an overview of the process outlined in FIG. 8, one or more of the lock(s)/doorbell(s) 202, mobile device 204, and/or hub 206 may send an emergency signal at step 801. At step 802, the cloud server 208 may receive the emergency signal. At step 804, the cloud server 208 may initiate an action (e.g., a first action, such as activating an alarm of a smart lock system of the user) in a sequence of actions to protect the user of the alarm system. One or more of the lock(s)/doorbell(s) 202, mobile device 204, hub 206, and/or cloud server 208 may transmit data at step 805 related to the first action or step 801 in the sequence of actions. At step 806, the cloud server 208 may generate a first message. At step 808, the cloud server 208 may communicate the first message to one or more of the lock(s)/doorbell(s) 202, mobile device 204, and/or to hub 206. One or more of the lock(s)/doorbell(s) 202, mobile device 204, and/or hub 206 may transmit an optional confirmation at step 809a in response to receiving the first message from the cloud server 208. Further, the cloud server 208 may communicate with one or more of the monitoring service 214, dispatcher/operator 216, and/or police/emergency authority 218 at step 809b. Based on information received/transmitted in steps 802-808, one or more of the monitoring service 214, dispatcher/operator 216, and/or police/emergency authority 218 may optionally transmit information back to the cloud server 208. At step 810, the cloud server 208 may initiate a second action (e.g., of the sequence of actions). At step 812, the cloud server 208 may generate a second message. The second message may be information associated with the second action initiated at step 810. Further, at step 814, the cloud server 208 may communicate the second message to one or more of the lock(s)/doorbell(s) 202, mobile device 204, and/or hub 206, and one or more of the lock(s)/doorbell(s) 202, mobile device 204, and/or hub 206 may transmit an optional confirmation back to the cloud server 208. In some embodiments, the process 800 may continue with additional actions (e.g., additional second actions, third actions, fourth actions, etc.) in the sequence of actions being performed to protect the user of the alarm system. For example, notifications/messages related to the various additional/alternative actions may be generated, transmitted, and otherwise utilized as described regarding the first action/first message in steps 804-808 and/or the second action/second message in steps 810-814.

In some embodiments, at step 802, the cloud server 208 may receive an emergency signal sent by one or more of the lock(s)/doorbell(s) 202, mobile device 204, and/or hub 206 of the alarm system of the user. For example, the user may report an emergency event (e.g., home fire, break in, etc.) using alarm interface application (e.g., the alarm interface 706 shown on FIG. 7). In another example, the hub 206 may automatically detect an emergency event based on data received from one or more devices of the smart lock/alarm system (e.g., via a sensor included in lock(s)/doorbell(s) 202, such as a camera sensor to detect an intruder; by using other devices such as smoke detectors, glass break detectors, or carbon monoxide detectors incorporated in the alarm system; etc.). The lock(s)/doorbell(s) 202, mobile device 204, and/or hub 206 can further transmit data or information indicative of the emergency event (e.g., emergency event type, time of emergency, whether the emergency was triggered automatically or via a user interacting with a device, information associated with the user (e.g., phone number, home address, emergency contacts, etc.)) to the cloud server 208 for further use in the process 800.

At step 804, the cloud server 208 may initiate a sequence of actions (e.g., by initiating a first action in a sequence of actions to protect the user of the alarm system). As described above regarding FIG. 2, the sequence of actions may include various steps, tasks, and activities and corresponding notifications/messages to protect the user of the alarm system. For example, the sequence of actions (e.g., performed by cloud server 208 of FIG. 2, etc.) can include the first through sixth messages/actions as described regarding FIG. 2, additional and/or alternative messages/actions, etc. In some embodiments, at step 804, the cloud server 208 may perform the first action by determining that the user's alarm system is triggered (e.g., activated). After performing the first action/initiating the sequence of actions in step 804, the cloud server 208 may optionally transmit data between and/or receive data from one or more of the lock(s)/doorbell(s) 202, mobile device 204, and/or hub 206. For example, the cloud server 208 may transmit data (e.g., via a signal) to the hub 206 to cause a smart lock device (e.g., lock(s)/doorbell(s) 202) to output an audible signal associated with a delay period of the alarm system. In another example, the mobile device 204 may transmit data to the cloud server 208 (e.g., user data such as home address, emergency contacts, and/or username; geographic data such as GPS location; etc.), and the cloud server 208 may further use the transmitted data in generating the first message in step 806, in performing subsequent actions and sending corresponding messages, etc.

At step 806, the cloud server 208 may generate a first message. In some embodiments, the first message generated at step 806 may correspond to the first action/initial action in the sequence of actions (e.g., performed in step 804) and may provide the user with information related to the first action in the message (e.g., as described regarding FIGS. 4-5). For example, the first message may inform the user that the alarm system received an alarm trigger signal and will notify a monitoring service if further action is not taken by the user (e.g., the user disarming the alarm). At step 808, the cloud server 208 may communicate the first message to one or more of the lock(s)/doorbell(s) 202, mobile device 204, and/or hub 206. For example, the cloud server 208 may transmit the first message in step 808 as a push notification configured to be received via the mobile device 204 for display to the user (e.g., as described regarding FIGS. 4-5). The data communicated to the lock(s)/doorbell(s) 202, mobile device 204, and/or hub 206 in step 808 can include data comprising the first message and/or additional data (e.g., user data, emergency event data, etc.) for further use in assisting the user with the emergency event.

After generating and communicating the first message in steps 806-808, the cloud server 208 may optionally receive data from one or more of the lock(s)/doorbell(s) 202, mobile device 204, and/or hub 206 (e.g., as part of an optional confirmation of receipt of the first message). The data received by the cloud server 208 may be further utilized in performing subsequent actions (e.g., second action) and sending corresponding messages (e.g., second message), as described below. For example, in response to a user indicating that immediate assistance is needed via the mobile device 204 (e.g., by interacting with and responding to the first message as described regarding FIG. 6), the cloud server 208 may bypass one or more steps/actions in the sequence of actions to protect the user and immediately communicate with one or more of the monitoring service 214, dispatcher/operator 216, and/or police/emergency authority 218.

At step 810, the cloud server 208 may initiate a second action. In some embodiments, at step 804, the cloud server 208 may initiate and/or perform the first action in step 810 by fully activating an alarm included in the alarm system (e.g., by the cloud server 208 instructing the lock(s)/doorbell(s) 202, hub 206, etc. to output an audible signal associated with an official alarm activation) and/or contacting a professional monitoring service. At step 812, the cloud server 208 may generate a second message. In some embodiments, the second message generated at step 812 may correspond to the second action in the sequence of actions (e.g., performed in step 810) and may provide the user with information related to the second action (e.g., as described regarding FIGS. 4-5). For example, the second message may inform the user that the alarm has been activated and that a professional monitoring service will be contacted. At step 814, the cloud server 208 may communicate the second message to one or more of the lock(s)/doorbell(s) 202, mobile device 204, and/or hub 206 (e.g., as a push notification configured to be received via the mobile device 204 for display to the user (e.g., as described regarding FIGS. 4-5)). The data communicated to the lock(s)/doorbell(s) 202, mobile device 204, and/or hub 206 in step 814 can include data comprising the second message and/or additional data (e.g., user data, emergency event data, etc.) for further use in the process 800. Further, one or more of the lock(s)/doorbell(s) 202, mobile device 204, and/or hub 206 may transmit an optional confirmation after receiving the second message, and data received in this confirmation can be further used in performing subsequent actions, updating subsequent messages, etc. For example, the cloud server 208 may transmit data including the data received via the optional confirmation to one or more of the monitoring service 214, dispatcher/operator 216, and/or police/emergency authority 218. In some embodiments, the process 800 may further include various additional and/or alternative actions and/or messages (e.g., third action/message, fourth action/message, etc. as described regarding FIG. 2) being initiated, performed, and/or transmitted, as described above regarding the first action/first message (e.g., steps 804-808) or the second action/message (e.g., steps 810-814).

With regard to FIG. 9, a flowchart of an illustrative process 900 for providing monitoring dispatch notifications is shown, according to some embodiments. In a broad overview of the process 900 outlined in FIG. 9, one or more processors may monitor for an alarm trigger at step 902. In response to determining an alarm was triggered at step 904, process 900 may continue by the one or more processors initiating an entry delay and sending a first message at step 906. If a response is received from the user at step 908, the process 900 may continue with the processor(s) adjusting at least one second message at step 910 based on the response from the user. The process 900 may further continue by determining whether further assistance is needed at step 914 and, if further assistance is needed, repeating steps 908-912 until step 914 indicates that the user no longer needs assistance.

For example, at step 902, the processor(s) may monitor for an alarm trigger. At step 904, the processor(s) may determine whether an alarm has been triggered (e.g., determine whether a signal corresponding to an alarm activation signal has been has been transmitted, as described above regarding FIG. 8). If an alarm has not been triggered, the process 900 may return to the initial step 902 and continue to monitor for an alarm trigger (e.g., for an alarm activation, reported emergency event, etc.). If an alarm has been triggered, the process 900 may continue to step 906, and the processor(s) may initiate an entry delay and send a first message to the user. For example, the entry delay/first message associated with step 906 may correspond to a first action in a sequence of actions to protect the user of the alarm system (e.g., as described regarding FIG. 2).

Further, at step 908, the processor(s) may determine whether the user has provided a response (e.g., by interacting with a message/notification as described above regarding FIGS. 6-7). For example, the user can respond by long-pressing the first message (e.g., pressing and holding a message using a predefined pressing force and/or for a predetermined amount of time) and/or providing additional information via a user input/keyboard (e.g., as described above regarding FIG. 6). In another example, the user can respond by interacting with an alarm interface executed via the mobile device of the user, as described regarding FIG. 7 (e.g., by the user disarming the alarm system via the alarm interface). If the processor(s) determine that the user has provided a response in step 908, the process 900 may continue, and the processor(s) may adjust at least one second message at step 910 based on the user response before sending the adjusted second message at step 912. In some embodiments, the at least one second message may correspond to an action (e.g., a second action) in the sequence of actions to protect the user of the alarm system. If the processor(s) determine that the user has not provided a response, the process 900 may bypass step 910 (e.g., not adjust the second message based on user input) and perform step 912 of sending the at least one second message. At step 914, the processor(s) may determine whether further assistance is needed.

In some embodiments, the processor(s) may repeat steps 908-912 (e.g., determining whether a user has provided a response at step 908, optionally adjusting at least one second message at step 910, and/or sending the at least one second message at step 912) until step 914 indicates that the user no longer needs assistance related to the emergency event (e.g., the emergency event ending, being a “false alarm,” etc.). In other embodiments, the processor(s) may repeat steps 908-912 until each action in a sequence of actions to protect the user has been performed (e.g., first action/message through sixth action/message, as described regarding FIG. 2).

With regard to FIG. 10, a flowchart of an illustrative process 1000 for providing notifications to a user of an alarm system is shown, according to some embodiments. In some embodiments, one or more processors (e.g., cloud server 208 of FIG. 2 and FIG. 8) may receive an alarm trigger at step 1002 and initiate a sequence of actions at step 1004. Further, the processor(s) may initiate a first action of the sequence of actions at step 1006, generate a first message corresponding to the first action at step 1008, and communicate the first message to one or more components of the alarm system (e.g., as a push notification to a mobile device of the user) at step 1010. In some embodiments, the processor(s) may further initiate a second action at step 1012, generate a second message corresponding to the second action at step 1014, and communicate the second message at step 1016.

In some embodiments, the process 1000 may include additional or alternative steps based on user input (e.g., the user indicating that the alarm was a false alarm, etc.) and/or whether the device used to trigger the alarm is co-located with a mobile device of the user (e.g., whether a network address/notification address of the mobile device of the user is the same as the network address of the alarm system used to perform process 1000). In other embodiments, the processor(s) may repeat steps 1012-1016 for additional second actions (e.g., third action, fourth action, etc.) in a sequence of actions to protect the user of the alarm system (e.g., as described regarding FIG. 2).

One method of providing notifications to a user of an alarm system may include, in response to receiving an alarm trigger from an alarm system from amongst multiple alarm systems being used to monitor respective locations, initiating a sequence of actions to be performed to protect the user of the alarm system. In response to a first action of the sequence of actions being initiated, the method may include generating a first message indicating that the first action has been initiated and communicating the first message via a communications network to a network address associated with the user. In response to at least one second action being initiated, the method may include generating at least one second message indicating that the second action has been initiated and communicating the second message via the communications network to the network address associated with the user.

Generating the first message may further include automatically generating the first message in response to the first action of the sequence of actions being initiated.

The method may further include, in response to an input of the user using a predetermined gesture, generating at least one third message, and communicating the at least one third message via the communications network to the network address associated with the user to confirm receipt of the input of the user and to notify the user of at least one third action to be initiated.

Generating at least one-third message indicating the input of the user may further include generating the at least one third message indicating the input of the user is in response to the predetermined gesture of the user holding a button displayed on a user interface for an extended period of time.

The method may further include, in response to receiving the alarm trigger from the alarm system, determining a first location associated with the alarm trigger, determining a second location of an electronic device associated with the user, and determining whether the first and second locations are co-located or not co-located. In response to determining that the first and second locations are not co-located, the method may further include generating at least one first follow-up message to send to the user. In response to determining that the first and second locations are co-located, the method may further include generating at least one second follow-up message to send to the user and communicating the at least one second follow-up message via the communications network to the network address.

The method may further include, in response to determining that the first and second locations are not co-located, determining that a notification address associated with the alarm trigger is a network address associated with the user. Further, the notification address may be a network address of a mobile device of the user.

Determining a first location associated with the alarm trigger and a second location associated with the user may further include receiving geographic data from an electronic device of a user of the alarm system.

Communicating the first message or the at least one second message to the user via the communications network may further include communicating the first message or the at least one second message via a mobile application executed by a mobile device of the user.

Communicating the first message or the at least one second message to the user via the mobile application may further include communicating the first message or the at least one second message as a critical message that bypasses a security function of the mobile device.

Receiving the alarm trigger may include receiving the alarm trigger inclusive of an identifier indicative of the alarm trigger being manually or automatically activated.

Another embodiment relates to a system of providing notifications to a user of an alarm system including a non-transitory memory, an input/output (I/O) unit, and one or more processors in communication with the memory and I/O unit. In response to receiving an alarm trigger from an alarm system from amongst multiple alarm systems being used to monitor respective locations, the one or more processors) may initiate a sequence of actions to be performed to protect the user of the alarm system. In response to a first action of the sequence of actions being initiated, the one or more processors may generate a first message indicating that the first action has been initiated and communicate the first message via a communications network to a network address associated with the user. In response to at least one second action in the sequence of actions being initiated, the one or more processors can generate at least one second message indicating that the second action has been initiated and communicate the at least one second message via the communications network to the network address associated with the user.

The one or more processors may be further configured to generate the first message in response to the first action of the sequence of actions being initiated.

The one or more processors may be further configured to, in response to an input of the user using a predetermined gesture, generate at least one third message and communicate the at least one third message via the communications network to the network address associated with the user to confirm receipt of the input of the user and to notify the user of at least one third action to be initiated.

The one or more processors may be further configured to, in generating the at least one third message indicating the input of the user, generate the at least one third message indicating the input of the user is in response to the predetermined gesture of the user holding a button displayed on a user interface for an extended period of time.

The one or more processors may be further configured to, in response to receiving the alarm trigger from the alarm system, determine a first location associated with the alarm trigger, determine second location associated with the alarm trigger, and determine, whether the first and second locations are co-located or not co-located. In response to determining that the first and second locations are not co-located, the one or more processing circuits may be configured to generate at least one follow-up message to send to the user. In response to determining that that the first and second locations are co-located, the one or processors may be configured to generate at least one second follow-up message to send to the user and communicate the at least one second follow-up message via the communications network to the network address.

The one or more processors may be further configured to, in response to determining that the first and second locations are not co-located, determine that a notification address associated with the alarm trigger is a network address associated with the user. Further, the notification address may be network address of a mobile device of the user.

The one or more processors may be further configured to, in determining a first location associated with the alarm trigger and a second location associated with the user, receive geographic data from an electronic device of a second user of the alarm system.

The one or more processors may be further configured to, in communicating the first message or the at least one second message to the user via the communications network, communicate the first message or the at least one second message via a mobile application executed by a mobile device of the user.

The one or more processors may be further configured to, in communicating the first message or the at least one second message to the user via the mobile application, communicate the first message or the at least one second message as a critical message that bypasses a security function of the mobile device.

The one or more processors are further configured to, in receiving the alarm trigger, receive the alarm trigger inclusive of an identifier indicative of the alarm trigger being manually or automatically activated.

One method of notifying a user of an alarm system of actions being performed in service an alarm activation includes receiving, by the user via an electronic device, a first user-interactive message indicating that a first action of a sequence of actions to be performed in servicing the alarm activation has been initiated. The method may further include receiving at least one second user-interactive message indicating that at least one second action of the sequence of actions to be performed in servicing the alarm activation has been initiated, and the first and second messages may be different from one another.

Receiving the first user-interactive message may include receiving the first user-interactive message via a mobile electronic device of the user.

The method may further include receiving, from the user, a predetermined gesture of the first user-interactive message via an electronic display of the electronic device of the user.

The method may further include, in response to receiving the predetermined gesture from the user, communicating, by the electronic device, a message to a processing system via a communications network indicative of the predetermined gesture from the user and receiving at least one third user-interactive message from the processing system responsive to the predetermined gesture.

The method may further include communicating, by the alarm system, a physical location associated therewith and communicating, by the electronic device, a second physical location associated therewith. In response to a determination that the first and second physical locations are co-located being made, the method may further include receiving at least one first follow-up message for the user. In response to a determination that the first and second physical locations are not co-located with one another being made, the method may further include receiving at least one second follow-up message for the user.

The method may further include enabling the user to respond to the first user interactive message from the electronic device or a second electronic device located at a location of the alarm system, and the network address of the electronic device and a network address of the second electronic device may be different from one another.

The method may further include sending, by the electronic device, geographic data associated with the alarm system.

Displaying the first message or the at least one second message includes displaying the first message or the at least one second message by a mobile application being executed by the electronic device.

Receiving the first message or the at least one second message may include receiving the first message or the at least one second message as a critical message that bypasses a security function of the electronic device.

The method may further include enabling the user to trigger the alarm system via the electronic device by communicating an alarm trigger message to a hub located in a location at which the alarm system is installed.

Another embodiment relates to a system of notifying a user of an alarm system of actions being performed in servicing an alarm activation, including a non-transitory memory, an input/output (I/O) unit, and one or more processors in communication with the memory and I/O unit. The or more processors may be configured to receive, by a user via an electronic device, a first user-interactive message indicating that a first action of a sequence of actions to be performed in servicing the alarm activation has been initiated. Further, the one or more processors may be configured to receive at least one second user-interactive message indicating that at least one second action of the sequence of actions to be performed in servicing the alarm activation has been initiation, and the first and second messages may be different from one another.

The one or more processors may be further configured to, in receiving the first user-interactive message, receive the first user-interactive message via a mobile electronic device of the user.

The one or more processors may be further configured to receive, from the user, a predetermined gesture of the first user-interactive message via an electronic display of the electronic device of the user.

The one or more processors may be further configured to communicate, by the electronic device, a message to a processing system via a communications network indicative of the predetermined gesture from the user and receive at least one third user-interactive message from the processing system responsive to the predetermined gesture.

The one or more processors may be further configured to communicate, by the alarm system, a physical location associated therewith and communicate, by the electronic device, a second physical location associated therewith. In response to a determination that the first and second physical locations are co-located being made, the one or more processors may be configured to receive at least one first follow-up message for the user. In response to a determination that the first and second physical locations are not co-located being made, the one or more processors may be configured to receive at least one second follow-up message for the user.

The one or more processors may be further configured to enable the user to respond to the first-user interactive message from the electronic device or a second electronic device located at a location of the alarm system. Further, a network address of the electronic device and a network address of the second electronic device may be different from one another.

The one or more processors may be further configured to send, by the electronic device, geographic data associated with the alarm system.

The one or more processors circuits may be further configured to, in displaying the first message or the at least one second message, display the first message or the at least one second message by a mobile application being executed by the electronic device.

The one or more processors may be further configured to, in receiving the first message or the at least one second message, receive the first message or the at least one second message as a critical message that bypasses a security function of the electronic device.

The one or more processors may be further configured to enable the user to trigger the alarm system via the electronic device by communicating an alarm trigger message to a hub located in a location at which the alarm system is installed.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer or service or entirely on the remote computer or server or set of servers. In the latter scenario, the remote computer may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A method of providing notifications to a user, said method comprising:
in response to receiving an alarm trigger from an alarm system from amongst multiple alarm systems being used to monitor respective locations, initiating a sequence of actions to be performed to protect the user of the alarm system;
in response to a first action of the sequence of actions being initiated, generating a first message indicating that the first action has been initiated;
communicating the first message via a communications network to a network address associated with the user;
outputting information indicative of the first message via a graphical user interface (GUI) of an alarm status tracker application executing on a mobile device of the user;
in response to at least one second action in the sequence of actions being initiated, generating at least one second message indicating that the second action has been initiated;
communicating the at least one second message via the communications network to the network address associated with the user; and
outputting information indicative of the at least one second message via the GUI of the alarm status tracker application.

2. The method of claim 1, wherein generating the first message includes automatically generating the first message in response to the first action of the sequence of actions being initiated.

3. The method of claim 1, further comprising:
in response to an input of the user using a predetermined gesture, generating at least one third message; and
communicating the at least one third message via the communications network to the network address associated with the user to confirm receipt of the input of the user and to notify the user of at least one third action to be initiated.

4. The method of claim 3, wherein generating at least one-third message indicating the input of the user includes generating the at least one third message indicating the input of the user is in response to the predetermined gesture of the user holding a button displayed on a user interface for an extended period of time.

5. The method of claim 1, further comprising:
in response to receiving the alarm trigger from the alarm system:
determining a first location associated with the alarm trigger;
determining a second location of an electronic device associated with the user;
determining whether the first and second locations are co-located or not co-located;
in response to determining that the first and second locations are not co-located, generating at least one first follow-up message to send to the user;
in response to determining that the first and second locations are co-located, generating at least one second follow-up message to send to the user; and
communicating the at least one second follow-up message via the communications network to the network address.

6. The method of claim 5, further comprising, in response to determining that the first and second locations are not co-located, determining that a notification address associated with the alarm trigger is a network address associated with the user, wherein the notification address is a network address of the mobile device of the user.

7. The method of claim 6, wherein determining the first location associated with the alarm trigger and the second location associated with the user further includes receiving geographic data from an electronic device of the user.

8. The method of claim 1, wherein communicating the first message or the at least one second message to the user via the communications network further includes:
communicating the first message or the at least one second message via a mobile application executed by the mobile device of the user.

9. The method of claim 8, wherein communicating the first message or the at least one second message to the user via the mobile application further includes communicating the first message or the at least one second message as a critical message that bypasses a security function of the mobile device.

10. The method of claim 1, wherein receiving the alarm trigger includes receiving the alarm trigger inclusive of an identifier indicative of the alarm trigger being manually or automatically activated.

11. A system of providing notifications to a user of an alarm system, said system comprising:
a non-transitory memory;
an input/output (I/O) unit;
one or more processors in communication with the memory and I/O unit, the one or more processors being configured to:
in response to receiving an alarm trigger from an alarm system from amongst multiple alarm systems being used to monitor respective locations, initiate a sequence of actions to be performed to protect the user of the alarm system;
in response to a first action of the sequence of actions being initiated, generate a first message indicating that the first action has been initiated;
communicate the first message via a communications network to a network address associated with the user;
in response to at least one second action in the sequence of actions being initiated, generate at least one second message indicating that the second action has been initiated; and
communicate the at least one second message via the communications network to the network address associated with the user.

12. The system of claim 11, wherein the one or more processors are further configured to generate the first message in response to the first action of the sequence of actions being initiated.

13. The system of claim 11, wherein the one or more processors are further configured to:
in response to an input of the user using a predetermined gesture, generate at least one third message; and
communicate the at least one third message via the communications network to the network address associated with the user to confirm receipt of the input of the user and to notify the user of at least one third action to be initiated.

14. The system of claim 13, wherein the one or more processors are further configured to, in generating the at least one third message indicating the input of the user, generate the at least one third message indicating the input of the user is in response to the predetermined gesture of the user holding a button displayed on a user interface for an extended period of time.

15. The system of claim 11, wherein the one or more processors are further configured to:
in response to receiving the alarm trigger from the alarm system:
determine, by the one or more processors, a first location associated with the alarm trigger;
determine, by the one or more processors, a second location associated with the alarm trigger;
determine, by the one or more processors, whether the first and second locations are co-located or not co-located;
in response to determining that the first and second locations are not co-located, generate at least one follow-up message to send to the user;
in response to determining that that the first and second locations are co-located, generate at least one second follow-up message to send to the user; and
communicate the at least one second follow-up message via the communications network to the network address.

16. The system of claim 15, wherein the one or more processors are further configured to, in response to determining that the first and second locations are not co-located, determine that a notification address associated with the alarm trigger is a network address associated with the user, wherein the notification address is a network address of the mobile device of the user.

17. The system of claim 16, wherein the one or more processors are further configured to, in determining the first location associated with the alarm trigger and the second location associated with the user, receive geographic data from an electronic device of a second user of the alarm system.

18. The system of claim 11, wherein the one or more processors are further configured to, in communicating the first message or the at least one second message to the user via the communications network, communicate the first message or the at least one second message via a mobile application executed by a mobile device of the user.

19. The system of claim 18, wherein the one or more processors are further configured to, in communicating the first message or the at least one second message to the user via the mobile application, communicate the first message or the at least one second message as a critical message that bypasses a security function of the mobile device.

20. A computer-implemented method of notifying a user of an alarm system of actions being performed in servicing an alarm activation, said method comprising:
receiving, by the user via an electronic device, a first user-interactive message indicating that a first action of a sequence of actions to be performed in servicing the alarm activation has been initiated; and
receiving at least one second user-interactive message indicating that at least one second action of the sequence of actions to be performed in servicing the alarm activation has been initiated, the first and second messages being different from one another.
